(19) United States
(12) Patent Application Publication
(10) Pub. No.: US 2012/0139162 A1
(43) Pub. Date: Jun. 7, 2012

(54) DEVICE AND METHOD FOR CASTING A COMPONENT

(75) Inventor: Frank Heumann, Glinde (DE)

(73) Assignee: ILLINOIS TOOL WORKS INC., Glenview, IL (US)

(21) Appl. No.: 13/390,148

(22) PCT Filed: Aug. 12, 2010
(86) PCT No.: PCT/US10/45324

§ 371 Date: Feb. 13, 2012

(30) Foreign Application Priority Data
Aug. 13, 2009 (DE) 102009038647.5

(51) Int. Cl. B28B 7/20; B29C 39/34

(52) U.S. Cl. 264/318; 425/186

(57) ABSTRACT

The invention relates to a device for casting a component having undercuts, comprising a casting mold with at least one first casting core and at least one second casting core, wherein the first casting core comprises at least two arms extending from a common carrying section, which arms delimit between each other a free space and which arms, in the area of their free ends on outer surfaces facing away from one another or on inner surfaces facing toward one another, comprise at least one projection respectively, for forming at least one undercut on a component respectively, and wherein the second casting core can be placed onto the first casting core such that the arms of the first casting core can be pressed away from one another at least in the area of their free ends from an idle position or wherein the second casting core can be placed onto the first casting core such that the arms of the first casting core can be pressed toward one another at least in the area of their free ends from an idle position, and wherein the arms are elastic such that upon removal of the second casting core they move back into their idle position self-actuated.

The invention relates to a device and a method for casting a component having one or more undercuts. In the copying of undercuts by means of casting methods, there is the problem, after the casting operation, of removing the cast components from the casting cores copying the undercuts. Particularly when two opposite undercuts are to be formed on a component, the removal operation is relatively complicated. The corresponding casting molds therefore have to be equipped, for example, with a plurality of casting cores in order to be able to suitably copy the undercuts and remove them from the molds. It has also already been proposed to use collapsible casting cores in order to copy undercuts. However, the known casting devices are complicated in terms of assembly and use. Moreover, there is a risk of damage to the components to be produced, which are often very small, and, in particular, to the undercuts during removal from the mold.

Proceeding from the prior art explained, the object on which the invention is based is to provide a device and a method of the type initially mentioned, by means of which high-quality components with undercuts which, in particular, lie opposite one another can be produced in a simple way.

The invention achieves this object by means of the subjects of the independent claims 1 and 12. Advantageous refinements are found in the dependent claims, the description and the figures.

The invention achieves the object, on the one hand, by means of a device for casting a component with undercuts, comprising a casting mold with at least one first casting core and at least one second casting core, wherein the first casting core comprises at least two arms extending from a common carrying section, which arms delimit between each other a free space and which arms, in the area of their free ends on outer faces facing away from one another or on inner faces facing toward one another, comprise at least one projection respectively for forming at least one undercut on a component respectively, and wherein the second casting core can be placed onto the first casting core such that the arms of the first casting core can be pressed away from one another at least in the area of their free ends from an idle position, or wherein the second casting core can be placed onto the first casting core such that the arms of the first casting core can be pressed toward one another at least in the area of their free ends from an idle position, and wherein the arms are elastic such that upon removing the second casting core they move back into their idle position self-actuated.

The component to be produced according to the invention may, for example, be a component of an automobile. The projections and the free space are preferably provided in the area of the free ends of the first casting core. During casting, the projections copy the undercuts in the component. The projections may, in particular, be arranged opposite one another, so that the undercuts copied in the component also lie opposite one another. The component may, for example, possess a U-shape. The undercuts can then be formed, for example, on mutually opposite inner surfaces of the legs of the component. The arms of the first casting core have an elongate shape and can run essentially parallel to one another in the idle position and/or in the pressed-away or pressed-together position.

By means of the collapsible first casting core according to the invention, it becomes possible in a simple way to form, in particular, opposite undercuts on a component by means of a casting method. In particular, the device according to the invention is in this case simple to assemble. After casting, the casting produced can then be removed from the mold in a simple way, without the risk of damage to the component or to the undercuts. Precisely in the case of the small components according to the invention, which are to be produced and which have lateral dimensions in the range of a few centimeters or less, this is especially important. According to the invention, the quality of the components is increased and the production costs are reduced.

According to a first refinement, the projections may be provided on outer surfaces of the arms of the first casting core which face away from one another and the second casting core may comprise at least one pressure section which can be inserted into the free space of the first casting core such that the arms of the first casting core are pressed away from one another at least in the area of their free ends from their idle position, whereby the projections are distanced from one another. The pressure section of the second casting core may have an elongate form and taper in the direction of one of its free ends. The tapering free end is then inserted into the free space of the first casting core. The, for example, conical taper makes it easier to insert the pressure section into the free space. According to the invention, the pressure section can be pushed into the free space, in particular, from the side lying opposite the carrying section of the first casting core. Furthermore, it is possible that the projections of the first casting core can, as a result of the insertion of the pressure section into the free space, be pressed away from one another at least as far as the projections project beyond the outer surfaces of the arms. In cylindrical projections, for example, the aims can therefore respectively be pressed outward at least as long as the projections are in the direction of their cylinder axis. Particularly when the projections are formed in the area of the free ends, therefore, the free ends of the arms can be moved correspondingly out from one another. This makes removal from the mold easier, since the projections of the casting core, after removal of the pressure section, are drawn back automatically, and, in particular, completely out of the undercuts copied by them.

According to a second, alternative refinement, there may be provision whereby the projections are provided on inner surfaces of the arms of the first casting core which face toward one another, and whereby the second casting core comprises at least two arms also extending from a carrying section, wherein the second casting core can be placed onto the first casting core with its two arms such that the first casting core is received with its arms and its carrying section between the arms of the second casting core, so that the arms of the first casting core are pressed toward one another at least in the area of their free ends from an idle position, whereby the projections move toward each other. In this refinement, therefore, the arms of the first casting core are pressed together for the casting operation. For this purpose, the casting cores are pushed one into the other, while the carrying sections of the casting cores and the arms can lie one against the other. In this state, the arms of the casting core can run in each case parallel to one another. After the casting and removal of the second casting core, the aims move away from one another again, the projections being drawn out of the undercuts.

Furthermore, once again, they may advantageously be provisioned whereby the projections of the first casting core can be moved toward one another, upon placing the second casting core with its arms onto the first casting core, at least as far as the projections project beyond the inner surfaces of the arms. As in the first refinement described above, in which the projections are arranged on the outer surfaces of the arms this makes removal from the mold easier.

The carrying section of the first casting core may form together with the arms of the first casting core a fork shape. In the abovementioned second refinement with a second casting core likewise comprising two arms emanating from a carrying section, the carrying section of the second casting core may also form, together with the arms of the second casting core, a fork shape.

According to a further refinement, the projections may be cylindrical. Cylindrical recesses, in particular cylindrical blind holes, are therefore generated as undercuts in the component. The first component may be intended to interact with a second component which has projections corresponding to the undercuts of the first component. In this refinement, the projections of the second component may, for example, be cylindrical trunnions, by means of which the component can be inserted into the cylindrical undercuts of the first component and can be mounted, for example, pivotably in these.

According to a further refinement, at least the first casting core may consist of a spring steel material. In this refinement, the first casting core therefore possesses, simply on account of its material, the elasticity or prestress which is necessary for the invention and which automatically moves it back from a pressed-away or pressed-together position into its idle position. It is also possible that the second casting core consists of a steel material, for example of a spring steel material. By contrast, the component to be cast may consist of a plastic. It can thus be produced in a simple way, for example in an injection molding method at the same time cost-effectively and with a low weight.
The invention also achieves the object by means of a method for casting a component comprising undercuts by means of a device according to the invention, comprising the following steps:
   the first casting core is provided in the casting mold,
   the second casting core is placed onto the first casting core such that the arms of the first casting core are pressed away from one another or moved toward one another at least in the area of their free ends from their idle position,
   the casting mold is closed and casting material is introduced into the casting mold via an inlet conduit,
   the casting mold is opened after a hardening time,
   the second casting core is removed from the first casting core, so that the arms of the first casting core move back into their idle position again, whereby the projections are retracted from the undercuts formed by the projections in the component.

According to a relevant refinement, the projections can be fully retracted from the undercuts upon the removal of a pressure section from the free space. The selected hardening time is in this case to be long enough for sufficient dimensional stability of the component to be cast. A sufficient dimensional stability means, in this context, that the casting is no longer deformed upon removal from the casting mold. For this purpose, it is not necessary to wait for a full hardening of the casting. It is sufficient, where appropriate, to have a sufficiently hardened shell which ensures dimensional stability. The core of the casting may in this case still be soft or even liquid and harden only thereafter. The production time can thereby be reduced. After the method steps according to the invention have been carried out, the casting can then be removed from the mold completely and taken out of the casting mold. Subsequently, the second component intended to interact with the first component and having projections corresponding to the undercuts of the first component can be produced, in particular cast. The casting material may again be a plastic, and therefore the casting method may be an injection molding method.

An exemplary embodiment of the invention is explained in more detail below by means of figures in which, diagrammatically:

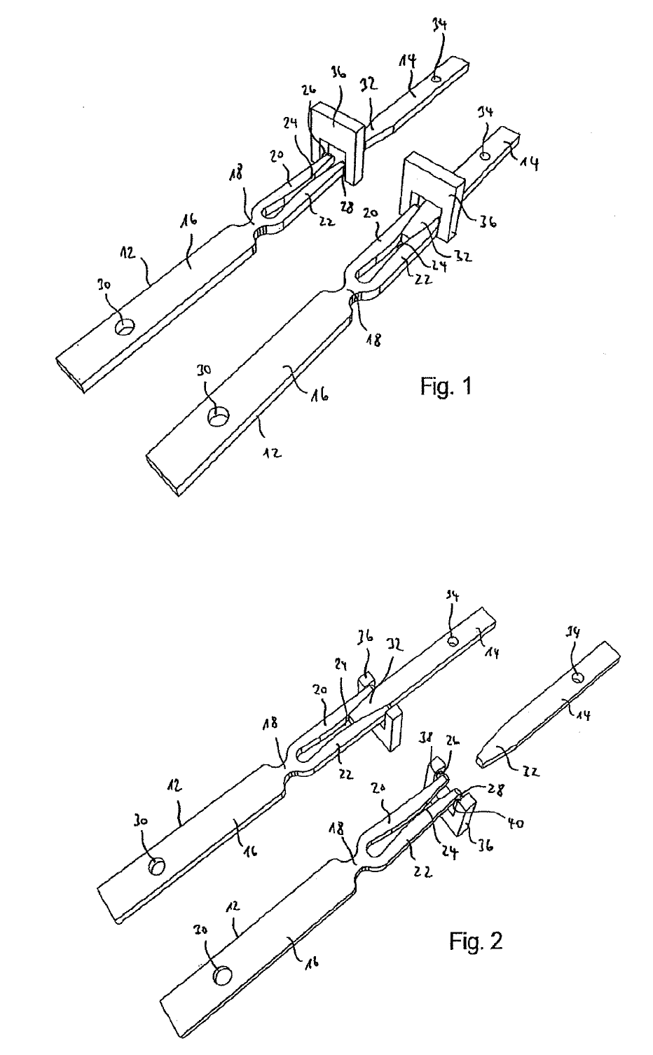

FIG. 1 shows a device according to the invention according to a first exemplary embodiment in two different operating states in perspective views,

FIG. 2 shows the device from FIG. 1 in two further operating states in perspective views,

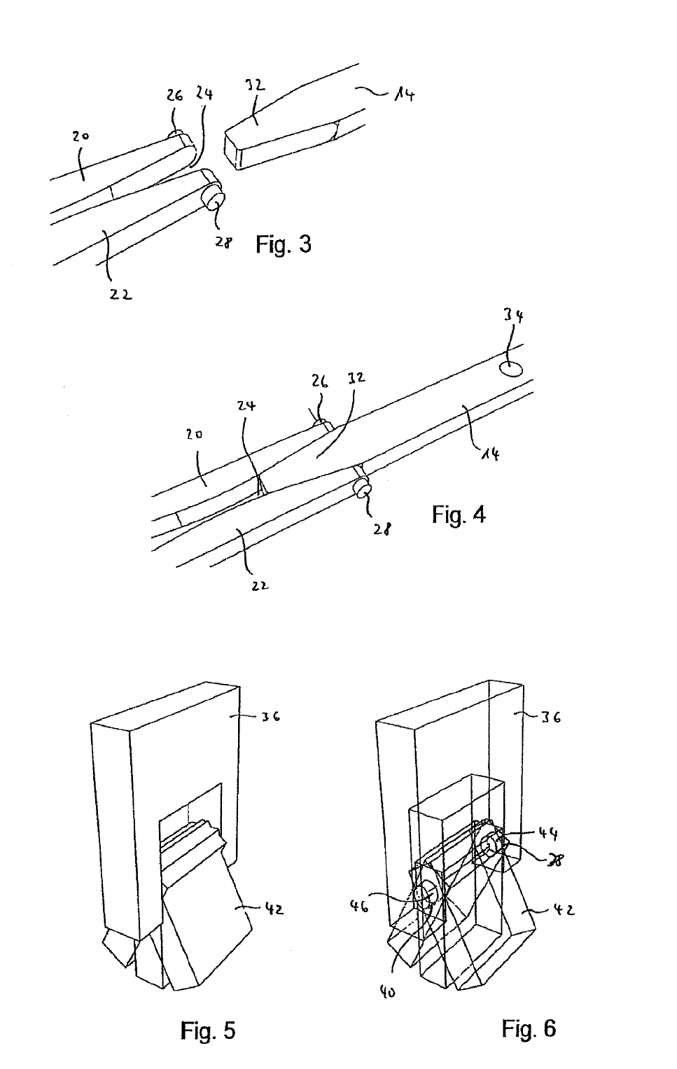

FIG. 3 shows an enlarged perspective illustration of a detail of the device shown in FIG. 1 in a first operating state,

FIG. 4 shows an enlarged perspective illustration of a detail of the device shown in FIG. 1 in a further operating state,

FIG. 5 shows a component produced by means of the device from FIG. 1, in states in which it is connected to a second component, in a perspective view,

FIG. 6 shows the illustration from FIG. 5 in a transparent perspective view,

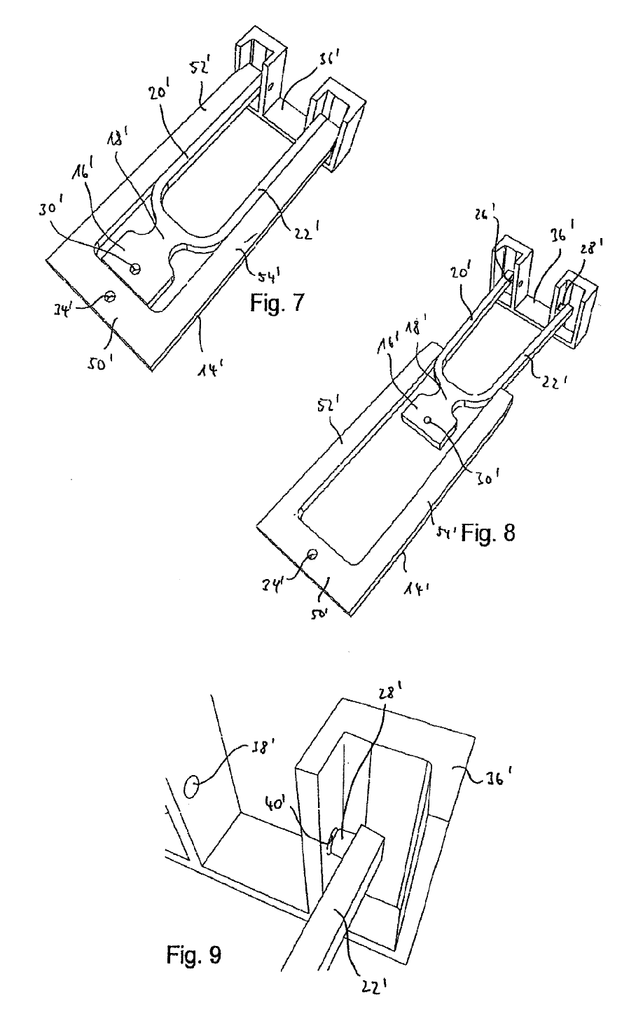

FIG. 7 shows a device according to the invention according to a second exemplary embodiment in a first operating state in a perspective view,

FIG. 8 shows the device from FIG. 7 in a further operating state in a perspective view, and

FIG. 9 shows an enlarged perspective illustration of a detail of the device shown in FIG. 8.

Unless specified otherwise, the same reference symbols denote identical objects in the figures. FIG. 1 illustrates a device according to the invention according to a first exemplary embodiment for casting a component having two opposite undercuts, in two operating positions. The device possesses a casting mold, not illustrated in any more detail for the sake of clarity, and also a first casting core 12 and a second casting core 14. The first casting core 12 possesses a largely parallelepiped carrying section 16 which at one end has a taper 18. Two arms 20, 22, running essentially parallel in the operating position shown in the bottom right section of FIG. 1 extend from the taper 18 of the carrying section 16. The carrying section 16 consequently forms, together with the arms 20, 22, a fork shape. The arms 20, 22 form together with the taper 18 a U-shape and between them delimit a free space 24. In each case a cylindrical projection 26, 28 is formed in the region of their free ends on the outer surfaces of the arms 20, 22 which face away from one another. The cylindrical projections 26, 28 extend along a common cylinder axis. They can be seen clearly in the enlarged illustrations, in the form of a detail, of FIGS. 3 and 4. The carrying section 16 possesses in the area of its end facing away from the arms 20, 22 a bore 30 of circular cross section which serves for fixing the first casting core 12 in the casting mold. In the example illustrated, the first casting core 12 consists of a spring steel. The second casting core 14 likewise possesses an elongate, in particular parallelepipedal configuration. It consists of a steel material. The second casting core 14 possesses in the area of one of its two free ends a tapering pressure section 32. The second casting core 14 again possesses, at its end facing away from the pressure section 32, a bore 34 of circular cross section for fixing on the casting mold. The device serves for casting an essentially U-shaped component from a plastic material, shown diagrammatically at reference symbol 36 in FIGS. 1 and 2. While the component 36 is illustrated from above in FIG. 1, the component 36 is shown from below in FIG. 2.

The device works as follows: in FIG. 1, in the top left section, the device is shown in a first operating position during mounting in the casting mold. The component 36 is in this case illustrated merely for clarity. In actual fact, it is cast only at a later time point. It can be seen in the top left part of FIG. 1 that the first casting core 12 and the second casting core 14 are oriented essentially along a common longitudinal axis with respect to one another, the tapering section 32 of the second casting core 14 facing the orifice in the free space 24 between the arms 20, 22 of the first casting core 12. Subsequently, the second casting core 14 is pushed into the tapering pressure section 32 into the free space 24 between the arms 20, 22. It can be seen that the arms 20, 22 together form, in the area of their free ends, a widening corresponding to the taper of the section 32 of the second casting core 14. The bottom right section of FIG. 1 shows the operating state in which the second casting core 14 is pushed with its pressure section 32 into the free space 24. In this case, the arms 20, 22 of the first casting core 12 are pressed elastically outward from the idle position shown in FIG. 1. In the example shown, as a result of the insertion of the pressure section 32, the arms 20, 22 are pressed away from one another as far as the cylindrical projections 26, 28 project from the arms 20, 22. Subsequently, the casting mold, not illustrated, is closed, a casting cavity which corresponds to the component 36 remaining. Thereafter, a plastic material is introduced in a liquid state into the casting mold in an injection molding method, so that the component 36 is copied in the casting cavity. This state with the copied component 36 is shown in FIG. 1 in the bottom right section and in FIG. 2 in the top left section. As soon as the component 36 has hardened sufficiently for dimensional stability, the casting mold is opened and the component 36 can be removed. For this purpose, the second casting core 14 is drawn with its pressure section 32 out of the free space 24. The arms 20, 22 thereby move toward one another into their idle position. The cylindrical projections 26, 28 of the arms 20, 22 are in this case drawn fully out of the component 36 cast around them. The component 36 can then be removed in a simple way. Cylindrical blind holes 38, 40 complementary to the cylindrical projections 26, 28 of the first casting core 12 remain in the component 36. These blind holes are likewise formed opposite one another, in the area of the free ends of the legs of the U-shaped component 36, on the inner surfaces lying opposite one another. They serve for receiving corresponding trunnions of a second component 42 which is likewise produced, for example, by an injection molding method and which is shown in the mounted state in FIGS. 5 and 6. The second component 42 is inserted with the cylindrical trunnions 44, 46 corresponding to the cylindrical undercuts 38, 40 of the first component 36 into the undercuts 38, 40 of the first component 36. Thus, the second component 42 is mounted pivotably on the first component 36. Pivotability is illustrated in FIGS. 5 and 6 in that the second component 42 is shown in three different pivoting positions.

FIGS. 7 to 9 show a device according to a second, alternative exemplary embodiment. The first casting core 12′ shown there corresponds largely to the casting core 12 from FIGS. 1 to 6. In particular, it also possesses, correspondingly to the first casting core 12 from FIGS. 1 to 6, a largely parallelepipedal carrying section 16′ which at one end has a taper 18′. Once again, two arms 20′, 22′ running largely parallel in the operating position shown in FIG. 7 extend from the taper 18′. The carrying section 16′ once again forms together with the arms 20′, 22′ a fork shape. The arms 20′, 22′ form together with the taper 18′ a U-shape and between them delimit a free space 24′. In contrast to the first casting core 12 shown in FIGS. 1 to 6, the casting 12′ shown in FIGS. 7 to 9 possesses the cylindrical projections 26′, 28′ on the inner surfaces of the free ends of its arms 20′, 22′. The second casting core 14′ differs from the second casting core 14′ shown in FIGS. 1 to 6 in that, like the first casting core 12′, it also has a carrying section 50′ and two arms 52′, 54′ running parallel and emanating from this. The second casting core 14′ therefore likewise possesses a fork shape. The two casting cores 12′, 14′ once again posses bores 30′, 34′.

In the casting position shown in FIG. 7, the first casting core 12′ is pushed into the second casting core 14′, the arms 52′, 54′ of the second casting core 14′ surrounding the arms 20′, 22′ of the first casting core 12′ at the same time pressing the arms 20′, 22′ inward toward one another from their idle position, the projections 26′, 28′ also moving toward one another. When the component 36′ is cast, the projections 26′, 28′ form corresponding undercuts 38′, 40′ in the component 36′. After the hardening of the component 36′ and the opening of the casting mold, the second casting core 14′ is drawn off from the first casting core 12′, as can be seen in FIG. 8. In this case, the arms 20′, 22′ of the first casting core move back automatically outward into their idle position. They are in this case, in particular, retracted fully from the undercuts 38′, 40′, as can be seen clearly in FIG. 9 as an enlarged illustration of a detail from FIG. 8.

The components 36, 36′, 42 produced according to the invention are intended for use in an automobile and are of small size. In particular, for example, the U-shaped first component 36, 36′ may possess a width of few centimeters, in particular less than 5 cm, a height of likewise a few centimeters, in particular less than 5 cm, and a thickness, for example, of less than 1 cm. By means of the device according to the invention and the method according to the invention, a component with opposite undercuts and a high quality can be produced in a simple way.

1. Device for casting a component with undercuts, comprising a casting mold with at least one first casting core and at least one second casting core, wherein the first casting core comprises at least two arms extending from a common carrying section, which arms delimit between each other a free space and which arms, in the area of their free ends on outer surfaces facing away from one another or on inner surfaces facing toward one another, comprise at least one projection, respectively, for forming at least one undercut on a component, respectively, and wherein the second casting core can be placed onto the first casting core such that the arms of the first casting core can be pressed away from one another at least in the area of their free ends from an idle position or wherein the second casting core can be placed onto the first casting core such that the arms of the first casting core can be pressed toward one another at least in the area of their free ends from an idle position, and wherein the arms are elastic such that upon removing of the second casting core they move back into their idle position self-actuated.

2. Device according to claim 1, characterized in that the projections are provided on outer surfaces of the arms of the first casting core, facing away from one another and that the second casting core comprises at least one pressure section which can be inserted into the free space of the first casting core such that the arms of the first casting core are pressed away from one another at least in the area of their free ends from an idle position, whereby the projections distance from one another.

3. Device according to claim 2, characterized in that the pressure section of the second casting core has an elongate form and tapers in the direction of a free end.

4. Device according to claim 2, characterized in that the projections of the first casting core can be pressed away from one another upon insertion of the pressure section into the free space at least as far as the projections project over the outer surfaces of the arms.

5. Device according to claim 1, characterized in that the projections are provided on inner surfaces of the arms of the first casting core facing toward one another and, that the second casting core comprises at least two arms also extending from a carrying section wherein the second casting core can be placed onto the first casting core with its two arms such that the first casting core is received with its arms and its carrying section between the arms of the second casting core, so that the arms of the first casting core are pressed toward one another at least in the area of their free ends from an idle position, whereby the projections (26, 28) move toward each other.

6. Device according to claim 5, characterized in that the projections of the first casting core can be moved toward one another upon placing the second casting core onto the first casting core at least as far as the projections project over the inner surfaces of the arms.

7. Device according to claim 1, characterized in that the projections are cylindrical.

8. Device according to claim 1, characterized in that the carrying section of the first casting core together with the arms provides a fork form.

9. Device according to claim 1, characterized in that at least the first casting core consists of a spring steel material.

10. Device according to claim 1, characterized in that the second casting core consists of a steel material, in particular a spring steel material.

11. Device according to claim 1, characterized in that the component to be cast consists of a plastic material.

12. Method for casting a component comprising undercuts with a device according to one of the preceding claims, characterized by the following steps:
the first casting core is provided in the casting mold,
the second casting core is placed onto the first casting core such that the arms of the first casting core are moved away from one another or moved toward one another at least in the area of their free ends from an idle position,
the casting mold is closed and casting material is introduced into the casting mold via an inlet conduit,
the casting mold is opened after a hardening time,
the second casting core is removed from the first casting core, so that the arms of the first casting core move back into their idle position, whereby the projections are retracted from the undercuts formed by the projections in the component.

13. Method according to claim 12, characterized in that the projections are fully retracted from the undercuts upon removing of the second casting core.

14. Method according to claim 12, characterized in that the casting material is a plastic material.
